(19) United States
(12) Patent Application Publication
(10) Pub. No.: US 2012/0330563 A1
(43) Pub. Date: Dec. 27, 2012

(54) Assembly Error Detection

(75) Inventors: Laxmi P. Parida, Mohegan Lake, NY (US); Niina Haiminen, White Plains, NY (US)

(73) Assignee: INTERNATIONAL BUSINESS MACHINES CORPORATION, Armonk, NY (US)

(21) Appl. No.: 13/605,119

(22) Filed: Sep. 6, 2012

Related U.S. Application Data
(63) Continuation of application No. 13/010,949, filed on Jan. 21, 2011.

(51) Int. Cl. G06F 19/24

(52) U.S. Cl. 702/19

(57) ABSTRACT

A method for detecting errors in genetic sequence assemblies including defining an assembly (A) of a sequence of genetic data, collecting read data into a library of reads (L), plotting histograms of sizes or reads versus a number of reads per size, normalizing a distribution (D) with a coverage C to obtain D′ that has a mean (μ) and standard deviation (σ) and reserve positions (i) not used to obtain D′, collecting subset of reads (Sᵢ⊂L) using A and D′, computing mean (μᵢ) and standard deviation (√cᵢ·σᵢ) using Sᵢ, outputting results to user on a display.

### CROSS-REFERENCE TO RELATED APPLICATIONS

This is a continuation application of and claims priority from U.S. application Ser. No. 13/010,949, filed on Jan. 21, 2011, the entire contents of which are incorporated herein by reference.

### FIELD OF INVENTION

The present invention relates to assembly error detection in deoxyribonucleic acid (DNA) and over and under-expression detections in Ribonucleic acid (RNA).

### DESCRIPTION OF RELATED ART

Deoxyribonucleic acid (DNA) genome sequences may be determined using methods that divide DNA into a number of segments or pieces having a number of bases in sequence. The determination of the sequence of the bases in each segment, in conjunction with determining the order of the segments, may be used to determine the overall sequence of the DNA. The determination of the order of the segments may be performed in-silico using bioinformatics assembly methods.

### BRIEF SUMMARY

In one aspect of the present invention a method for detecting errors in genetic sequence assemblies includes defining an assembly (A) of a sequence of genetic data, collecting read data into a library of reads (L), plotting histograms of sizes or reads versus a number of reads per size, normalizing a distribution (D) with a coverage C to obtain D′ that has a mean (μ) and standard deviation (σ) and reserve positions (i) not used to obtain D′, collecting subset of reads (Sᵢ⊂L) using A and D′, computing mean (μᵢ) and standard deviation (√cᵢ·σᵢ) using Sᵢ, outputting results to user on a display.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a plurality of DNA sequences and the division of the sequences into segments.

FIG. 2 illustrates an exemplary embodiment of a system 200 for determining error in a sequence.

FIGS. 3A and 3B illustrate a block diagram of an exemplary processing method that may be performed by the system of FIG. 2.

FIG. 4 illustrates a histogram of frequencies of reads.

### DETAILED DESCRIPTION

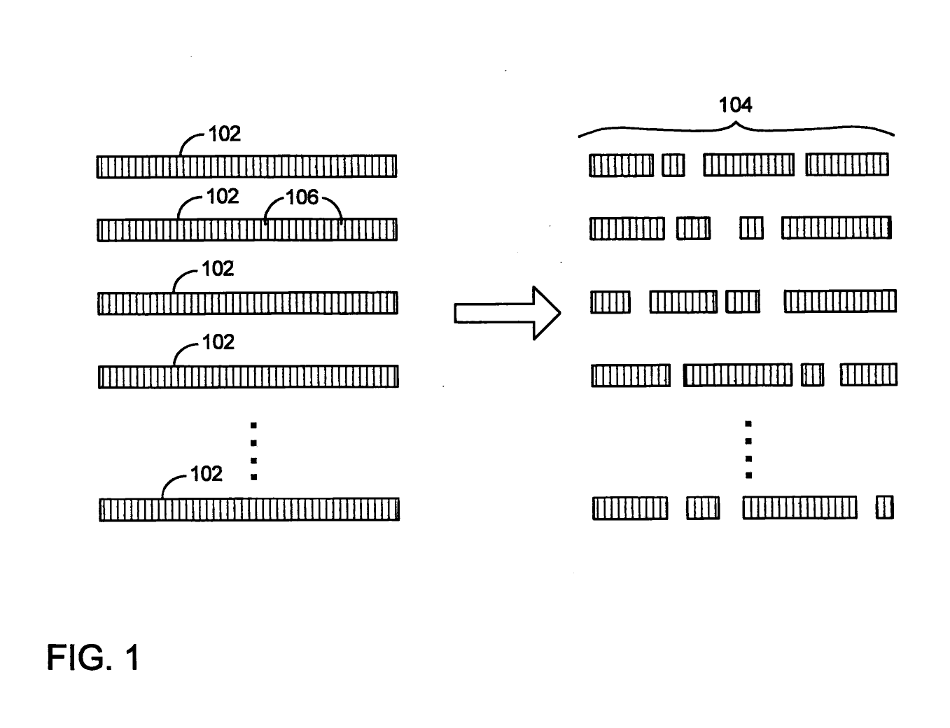

Deoxyribonucleic acid (DNA) genome sequences may be determined by dividing DNA into a number of segments or pieces having a number of bases in sequence, for example by using a compressed air device (nebulizer) or restriction enzymes. FIG. 1 illustrates a plurality of similar DNA sequences and the division of the sequences into segments. In this regard, a number of similar DNA strands 102 (e.g., 50 or more strands) may be split or cut into a plurality of segments 104 having a number of bases 106 ranging from, for example, 50 to 500 bases. The segments 104 are not necessarily cut into equal lengths. Once the segments 104 are cut, the segments 104 are read to identify the bases 106 and determine the position of the identified bases 106 in each segment; resulting in read data for each segment 104. Alternatively, the ends of the segments (e.g., 100 bases from each end) may be read to identify the bases. Reading the segments may be performed by, for example, a sequencing-by-synthesis process including fluorescent labeling of nucleotides and high resolution laser imaging. The resultant data includes a plurality of reads where each read identifies the bases 106 and positions of the bases 106 in each segment 104. The read data is grouped into a library of reads (L) that includes the frequency of reads at particular lengths (i.e., the number reads having a particular length of bases). Coverage (C) is the average number of copies of segments 104 overlapping a position in the sequenced DNA. Coverage C is known when the length of the DNA sequence is known, in addition to the lengths of sequenced segments 104. When the length of the DNA genome sequence is unknown, the user may provide an estimated length. The read data may be “reassembled” to result in an assembly (A) data that represents a portion of or the entire DNA genome sequence. The assembly may be performed by, for example, using an assembler (in-silico bioinformatics tool), considering the overlaps between the bases in the reads, and concatenating overlapping reads where possible. The assembly data includes vectors V=<i, cᵢl₁, l₂, . . . , l_{c}_{ᵢ}> that include the read count cᵢ and read lengths l at given position i. An example of a vector includes V=<34, 3, 10, 12, 102 >, indicating position 34 overlaps with 3 reads of lengths 10, 12, 102 respectively. The reassembly of the read data may include sequence errors in the assembly, since recovering the exact original order of the segments may be difficult. The exemplary methods and systems described below improve the detection of errors in the assembly.

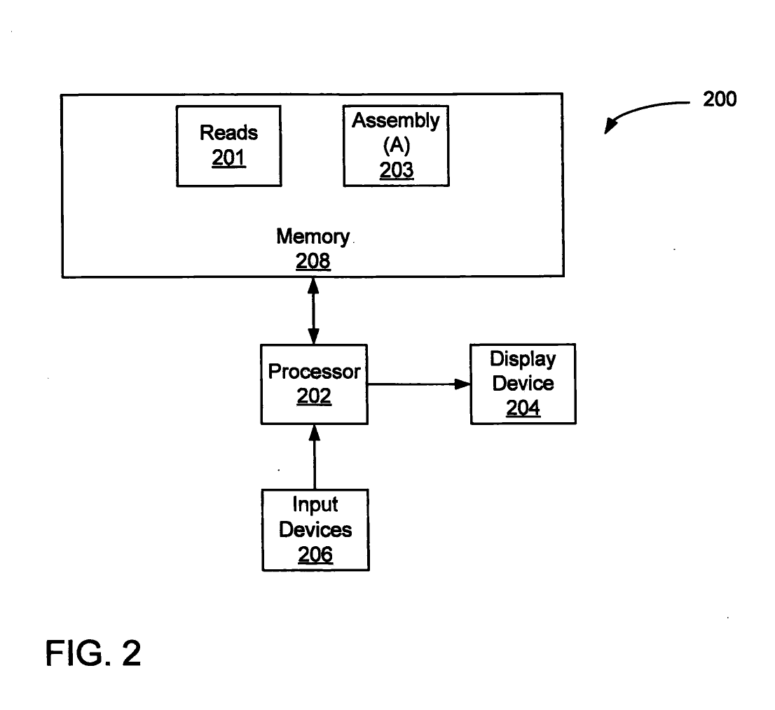

In this regard, FIG. 2 illustrates an exemplary embodiment of a system 200 for determining error in a sequence. The illustrated embodiment includes a processor 202 communicatively connected to a display device 204, input devices 206, and a memory 208 that stores the read data 201 and the assembly 203.

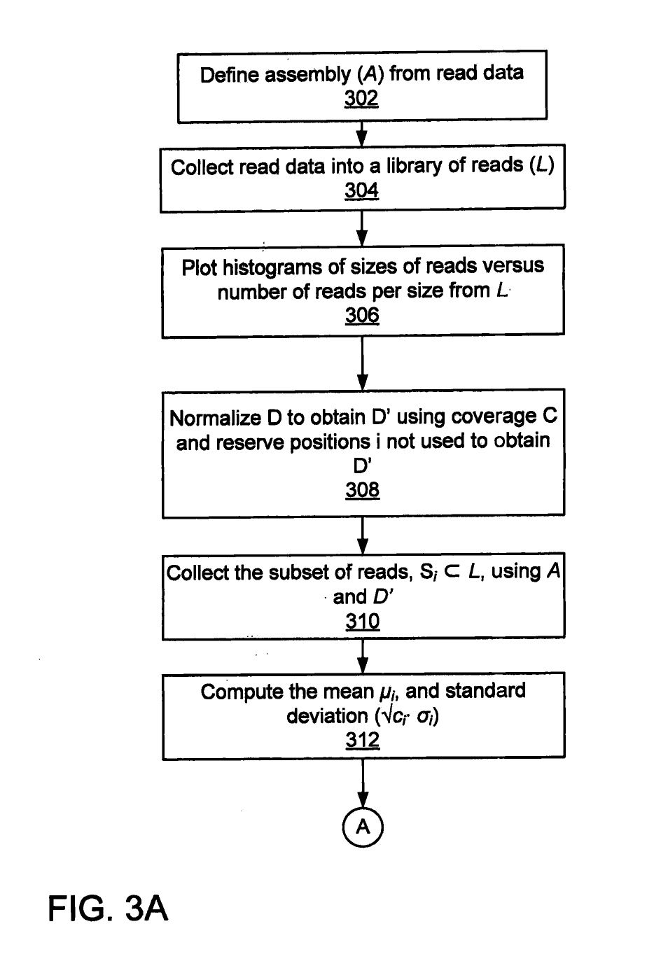

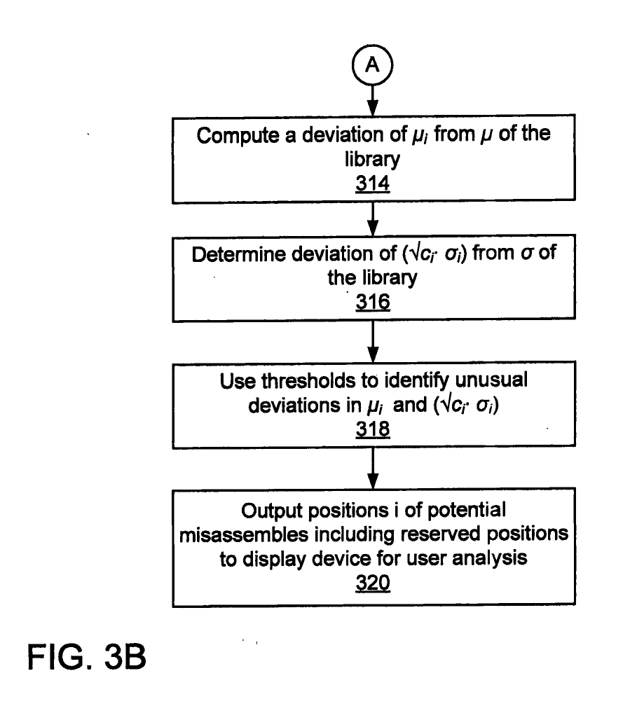

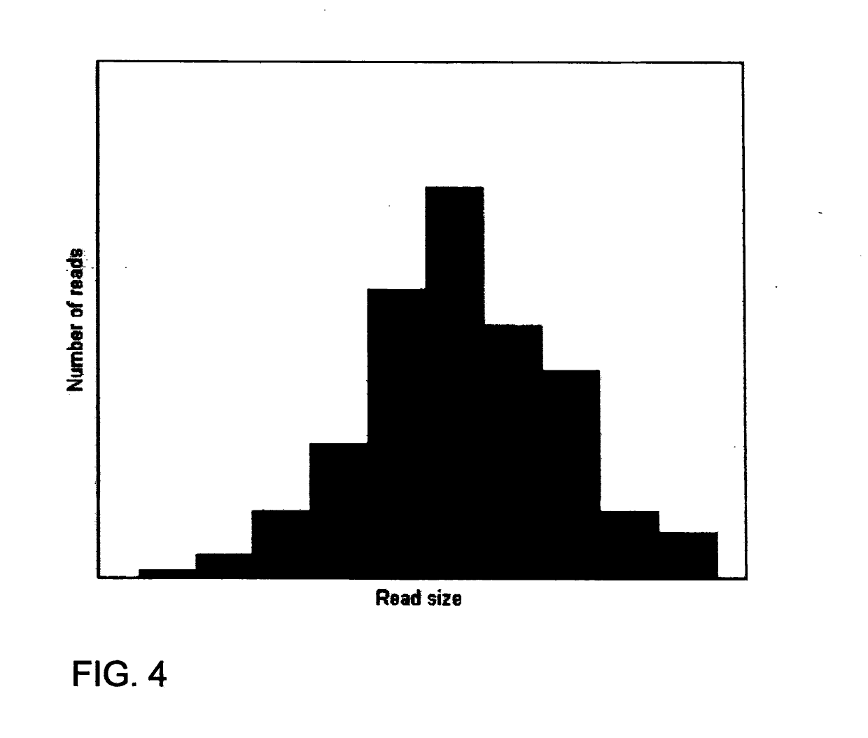

FIGS. 3A and 3B illustrate a block diagram of an exemplary processing method that may be performed by the system 200. Referring to FIG. 3A, an assembly (A) is defined that includes read data in block 302. In block 304, the read data is collected into a library of reads (L). Histograms of sizes of reads versus number of reads per size from L are plotted in block 306. An example of a histogram is illustrated in FIG. 4. The distribution D is normalized to obtain (D′) using coverage C where D′ is the expected standard distribution of L in block 310, and has mean μ and standard deviation σ. The normalization is performed using coverage C on A by filtering out the vectors V that are unlikely to represent the coverage C (using an upper and lower cut-off given by the user). The library is recomputed using the output of the last step. Positions (i) not used to obtain D′ are reserved. In block 310, for each position (i) in the assembly A, a subset of reads Sᵢ⊂L that overlap the position i is collected in vector Vᵢ. The mean (μᵢ) and standard deviation (√cᵢ·σᵢ) are calculated from S in block 312. In block 314 (of FIG. 3B), the deviation of from μᵢ of the library is computed. In block 316, the deviation of (√cᵢ·σᵢ) from a of the library is determined. Thresholds are used to determine unusual deviations (i.e., deviations outside the thresholds) in μᵢ and (√cᵢ·σᵢ) in block 318.

The results may be output to a display device for user analysis in block 320. For each position i in the assembly, when mean (μᵢ) deviates from the expected by more than a given threshold, or standard deviation (√cᵢ·σᵢ) is above a given threshold, the position i is flagged as potentially misassembled. The user can then focus on correcting the potential assembly mistakes in these flagged regions by re-assembling the data by another method, generating additional reads and re-assembling, or by using alternative sources of sequence information.

A similar process can be used for RNA data but the flagged positions are associated with over or under expression.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for detecting errors in genetic sequence assemblies, the method comprising:
defining an assembly (A) of a sequence of genetic data;
collecting read data into a library of reads (L);
plotting histograms of sizes or reads versus a number of reads per size;
normalizing a distribution (D) with a coverage C to obtain D′ that has a mean (μ) and standard deviation (σ) and reserve positions (i) not used to obtain D′;
collecting subset of reads (Sᵢ⊂L) using A and D′;
computing mean (μᵢ) and standard deviation (√cᵢ·σᵢ) using Sᵢ;
outputting results to user on a display.

2. The method of claim 1, wherein the method further includes computing a deviation of μᵢ from μ for each position (i) from the library of reads.

3. The method of claim 1, wherein the method further includes determining a deviation of √cᵢ·σᵢ from σ for each position (i) from the library of reads.

4. The method of claim 2, wherein the method further includes comparing the deviation to threshold values to identify deviations that are greater than or less than the threshold values.

5. The method of claim 3, wherein the method further includes comparing the deviation to threshold values to identify deviations that are greater than or less than the threshold values.

6. The method of claim 4, wherein the method includes outputting positions i of the identified deviations to a user on the display.

7. The method of claim 5, wherein the method includes outputting positions i of the identified deviations to a user on the display.

8. The method of claim 1, wherein the assembly is defined by in-silico bioinformatics methods for sequence assembly.

9. The method of claim 1, wherein the read data includes positions and identifiers of a plurality of bases in a segment of deoxyribonucleic acid (DNA).

10. The method of claim 1, wherein the library of reads includes a plurality of read data.
